(19) United States
(12) Patent Application Publication
(10) Pub. No.: US 2024/0337756 A1
(43) Pub. Date: Oct. 10, 2024

(54) INTEGRITY-CHECKING METHOD AND ASSOCIATED COMPUTER PROGRAM AND DEVICE

(71) Applicant: THALES, MEUDON (FR)

(72) Inventors: Philippe LAVIRON, BORDEAUX (FR); Pierre LOUVÉ, PARIS (FR)

(21) Appl. No.: 18/626,172

(22) Filed: Apr. 3, 2024

(30) Foreign Application Priority Data
Apr. 7, 2023 (FR) 2303479

(51) Int. Cl. G01S 19/07; G01S 19/10

(52) U.S. Cl. CPC G01S 19/07; G01S 19/10

(57) ABSTRACT

A method for checking an estimated location of a mobile machine receiving geopositioning signals from satellites, k=1 to s; a database storing the geographical coordinates of virtual beacons and the heading of the path segment on which the virtual beacon is located; a location indicating a virtual beacon, estimated to be on the same path segment as the machine, wherein for k=1 to s: the delay, Δτ_{S}_{ₖ}(t,B1), is computed between the geopositioning signal received from and the theoretical geopositioning signal; values hdg and RxB1 are estimated that respect:

$$Δ {τ}_{{S}_{1}} ( t , B 1 ) = \frac{1}{c} {( cos ( {el}_{1} ) )}^{- 1} cos ( {az}_{1}^{′} ) RxB 1 + {ε}_{1}$$

$$⋮$$

$$Δ {τ}_{{S}_{s}} ( t , B 1 ) = \frac{1}{c} {( cos ( {el}_{s} ) )}^{- 1} cos ( {az}_{s}^{′} ) RxB 1 + {ε}_{s}$$

the location being identified as unreliable depending on comparison of the estimated hdg with the stored value of the heading of the path segment of the beacon.

### CROSS-REFERENCE TO RELATED APPLICATION

This application claims priority to foreign French patent application No. FR 2303479, filed on Apr. 7, 2023, the disclosure of which is incorporated by reference in its entirety.

### FIELD OF THE INVENTION

The present invention relates to the field of checking the integrity of position estimations made via satellite geo-location.

### BACKGROUND

The absolute accuracy of a position obtained by a position-determining system, conventionally by triangulation of data generated by satellites and received by a satellite receiver, is tarnished by errors that may be expressed and summed as follows:

$${UERE}^{2} = {( {E}_{\_ SIS} )}^{2} + {( {E}_{\_ Tropo} )}^{2} + {( {E}_{\_ Iono} )}^{2} + {( {E}_{\_ Rx} )}^{2} + {( {E}_{\_ Multipath} )}^{2}$$

where
UERE is the user equivalent range error;
E__{SIS} represents signal-in-space errors, i.e. errors related to satellite transmission (satellite clock, path, etc.);
E__{Tropo} and E__{Iono} are errors related to interference due to reflection of the signal in space from the troposphere and ionosphere, respectively;
E__{Rx} are errors specific to the satellite receiver;
E__{Multipath} are errors due to reflection of the satellite signal from obstacles before reaching the satellite receiver.

Positioning error may be modeled and therefore estimated under the assumption that all the satellites are transmitting correctly and based on signal-to-noise ratio (SNR); however, the obtained value is a statistical value.

When safety is critical, in addition to absolute inaccuracy, the concept of integrity must be taken into account, which concept is closely associated with the envisioned application and described as follows:
a maximum tolerable inaccuracy limit, expressed in terms of an alert limit (AL) and of a radius (or level) of protection (LP), specific to the application: for example, in the railway sector, the value of 4 meters may be chosen as the maximum transverse error between tracks in the static case of starting a train, and the value of 30 meters may be chosen as the maximum longitudinal error in the dynamic case of a train in motion;
a maximum tolerable TTA (TTA standing for Time To Alert): i.e. the maximum tolerable length of time for fault detection, during which time the application is able to “live” with a position that is “outside acceptable limits”; an example of a TTA, in the railway sector, is a value of 3 seconds;
a tolerable probability of “missed detection”, Pnd, of anomalies (i.e. the probability of not detecting that the positioning error is beyond the maximum limit AL), in a given period of time: for example: 2×10⁻⁷ in 150 seconds; an availability of the service for which the accuracy is required: for example 95% of the time.

The evaluation of the integrity of a position (here position is considered to be the value of interest, but the same goes for other values, speed for example) aims to provide a measurement of the reliability of the position computed by a position-determining system, and to alert the user in the event of a position deemed unreliable.

Integrity is defined as the degree of confidence that it is possible to have in the location information provided by the system. It includes the ability to provide a valid alert in time, when the system must not be used during an operation.

The reliability of the position is measured by means of an integrity-checking algorithm via computation of a protection volume around the estimated position, this protection volume typically being (or comprising at least) a protection cylinder and representing a confidence index: the smaller the protection volume, the smaller the space for possible errors.

This protection volume is constructed from at least a horizontal protection level (HPL) and a vertical protection level (VPL).

In real time, the system does not in principle know its absolute positioning error. To decide whether the determined position is usable, and in particular to determine whether the error is below a set threshold, the computed protection levels are compared with alert levels: VPL is compared with the vertical alert level VAL and HPL is compared with the horizontal alert level HAL. If a protection level exceeds the alert level, the user must be alerted in a time shorter than the TTA, and the position is considered unusable, but the position-determining system still has integrity.

However, integrity is lost when the absolute positioning error is greater than the alert level, and when the algorithm does not detect it (protection level lower than the alert level).

The risk of loss of integrity IR is thus defined as follows:

$$IR = Probability ( XPE > XAL I XPL < XAL ) ,$$

with X taking the value V or H depending on whether the vertical or horizontal plane is considered, and
XPE being the distance between the determined position and the true position in the vertical or horizontal plane considered.

By way of illustration of the concept of integrity, FIG. 1 shows, seen from above, a railway track V that is being used by a train that has on board it a location-determining system. The plane of the figure corresponds to the horizontal plane. Three situations are described in succession, starting at the left of the figure and moving to the right. For each of these situations, the true position has been represented by a diamond, the position determined by the system has been represented by a dash and a protection cylinder, projected in the horizontal plane by a circle, has been considered.

In the first situation, to the left of FIG. 1, the computed protection level HPL is greater than the alert level HAL; it may be seen that HPE>HAL: the position determination of the system is considered unavailable but the system has integrity.

In the second situation, in the center of FIG. 1, the computed protection level HPL is less than the alert level HAL; it may be seen that HPE<HAL: the position determination of the system is considered available and the system has integrity.

In the third situation, to the right of FIG. 1, the computed protection level HPL is less than the alert level HAL; it may be seen that HPE>HAL: the position determination of the system is considered available and the system does not have integrity: it is in particular against this type of situation that the present invention is intended to defend.

The risk of loss of integrity, IR, is an input of the aforementioned algorithm that computes the protection levels. It is conventionally set at 10⁻⁷ in aviation; the target probabilities in the railway sector are of the order of 10⁻¹⁰.

In addition to the risk of loss of integrity, the algorithm for computing protection level is also fed as input a probability of false alarm, PFA, corresponding to the probability of detection of unreliability when the absolute error has not exceeded the alert level:

$$PFA = Probability ( XPL > XAL I XPE < XAL ) .$$

This probability is conventionally set at 0.01 in aviation, to which the availability of 99% corresponds, these parameters being complementary.

In the case of a GNSS positioning system (GNSS being the acronym of Global Navigation Satellite System), known integrity-checking algorithms in particular use the solutions GNSS RTK, SBAS, EGNOS, and RAIM, which have various drawbacks including: need for a certain number of available satellites to be visible (RAIM requires more than 5 satellites to be visible for detection purposes and to compute a protection level), and sensitivity to masking/multi-path/interference effects. Furthermore, the protection levels achieved with these methods do not allow track detection with integrity in the railway sector, where protection levels of 4 m at a risk of loss of integrity of 10⁻¹⁰ are required (compared for example to the 20 m protection level and 10⁻⁷ risk of loss of integrity in aviation).

There is therefore a need to provide a reliable integrity-checking solution applicable in particular to the constraints of the railway sector.

### SUMMARY OF THE INVENTION

The invention more particularly applies to integrity checking in the case of estimation of the position Pi₀ of a machine configured to move over a set of one or more predefined paths, said position having been estimated, by an electronic locating unit comprising a database, by comparing the likelihood of each of a plurality of hypotheses Pi, i=1 to N, in respect of position; said positions Pi being positions distributed over said set of one or more paths and the geographical coordinates of which are stored in said database;
the likelihood of a position having been determined by the locating unit based at least on geopositioning signals originating from a system of one or more geopositioning satellites and that are received, at a time t, by a satellite receiver located on board the machine, and for example based on the correlation between these geopositioning signals and geopositioning signals that should, according to computations, have been received at the time t at said position from the system of one or more satellites.

According to a first aspect, the present invention describes a method for checking an estimated location of a machine configured to move over a set of one or more predefined paths made up of path segments;
a satellite receiver located on board the machine being configured to receive, at a time t, geopositioning signals from a system of satellites comprising s satellites Sk, k=1 to s and s greater than or equal to 2;
a database storing the geographical coordinates of virtual beacons distributed over said set of one or more paths and further storing, for each virtual beacon, the heading of the path segment on which the virtual beacon is located;
a location at the time t of the machine as estimated indicating a virtual beacon B1 estimated as corresponding in principle to said location of the machine at the time t on the same path segment;
said method comprising the following steps, implemented by an electronic checking unit:
i/ for k=1 to s: computing the delay, Δτ_{S}_{ₖ}(t,B1), between the geopositioning signal received by the satellite receiver at the time t from satellite Sk and the theoretical geopositioning signal that should, according to computations, be received from satellite Sk at the time t at the position of the virtual beacon B1 such as defined by the geographical coordinates in the database;
ii/ estimating values [symbol] , [symbol] , of parameters hdg and RxB1, satisfying the system of equations:

$$\{ \begin{matrix}Δ {τ}_{{S}_{1}} ( t , B 1 ) = \frac{1}{c} {( cos ( {el}_{1} ) )}^{- 1} cos ( {az}_{1}^{′} ) RxB 1 + {ε}_{1} \\ Δ {τ}_{{S}_{s}} ( t , B 1 ) = \frac{1}{c} {( cos ( {el}_{s} ) )}^{- 1} cos ( {az}_{s}^{′} ) RxB 1 + {ε}_{s}\end{matrix}$$

where azₖ=hdg−azₖ modulo 2π and elₖ and azₖ are the, known, elevation and azimuth of satellite Sk at the time t, respectively;
iii/ comparing the estimated value [symbol] of the parameter hdg with the value, stored in the database, of the heading of the path segment on which the beacon B1 is located;
iv/ if the difference is greater than a first predefined threshold, said estimated location at the time t is identified as unreliable by said checking unit.

The present invention allows, with a simple architecture, a guarantee to be provided as to the absolute positioning accuracy of a mobile machine on a known path for critical safety applications (when human lives are at stake) with a stipulated risk of error, and allows an alert to be generated should the accuracy measurement lose integrity.

In some embodiments, such a method will further comprise at least one of the following features:
a target value, PMD_{track}, of a path misdetection probability having been set:
determining the threshold value [symbol] for which the condition “p(d≤( [symbol] +εᵣ)sin(ε_{hdg}))≤PMD_{track}” is met, εᵣ being the error between the true and estimated distances between the satellite receiver and the beacon B1 and ε_{hdg} being the difference between the heading estimated in step ii and the heading of the segment on which the beacon B1 is located as indicated in the database;
assigning the determined threshold value to a protection level PL;
determining that the estimated position is reliable or unreliable, respectively, depending on comparison of the protection level PL and a predefined alert limit AL;

the value [symbol] estimated in step ii/ is compared with half the minimum distance between two adjacent segments of distinct paths, and if said estimated value [symbol] is greater than said half the minimum distance, said estimated location at the time t is identified as unreliable by said checking unit.

According to another aspect, the invention describes a computer program intended to be stored in the memory of an electronic checking device and further comprising a microcomputer, said computer program comprising instructions that, when they are executed on the microcomputer, implement the steps of a method according to the first aspect of the invention.

According to another aspect, the invention describes an electronic device for checking an estimated location of a machine configured to move over a set of one or more predefined paths made up of path segments; a satellite receiver located on board the machine being configured to receive, at a time t, geopositioning signals from a system of satellites comprising s satellites Sk, k=1 to s and s greater than or equal to 2; a database storing the geographical coordinates of virtual beacons distributed over said set of one or more paths and further storing, for each virtual beacon, the heading of the path segment on which the virtual beacon is located;
a location at the time t of the machine as estimated indicating a virtual beacon B1 estimated as corresponding in principle to said location of the machine at the time t on the same path segment;
said electronic checking device being configured to compute, for k=1 to s, a delay, Δτ_{S}_{ₖ}(t,B1), between the geopositioning signal received by the satellite receiver at the time t from satellite Sk and the theoretical geopositioning signal that should, according to computations, be received from satellite Sk at the time t at the position of the virtual beacon B1 such as defined by the geographical coordinates in the database;
said electronic checking device being configured to estimate values, [symbol] , [symbol] , of respective parameters hdg and RxB1, satisfying the system of equations:

$$\{ \begin{matrix}Δ {τ}_{{S}_{1}} ( t , B 1 ) = \frac{1}{c} {( cos ( {el}_{1} ) )}^{- 1} cos ( {az}_{1}^{′} ) RxB 1 + {ε}_{1} \\ ⋮ \\ Δ {τ}_{{S}_{s}} ( t , B 1 ) = \frac{1}{c} {( cos ( {el}_{s} ) )}^{- 1} cos ( {az}_{s}^{′} ) RxB 1 + {ε}_{s}\end{matrix}$$

where azₖ=hdg−azₖ modulo 2π and elₖ and azₖ are the, known, elevation and azimuth of satellite Sk at the time t, respectively;
said electronic checking device being configured to compare the estimated value [symbol] of the parameter hdg with the value, stored in the database, of the heading of the path segment on which the beacon B1 is located, and, if the difference is greater than a first predefined threshold, to identify said estimated location at the time t as unreliable.

In some embodiments, such a device will further comprise at least one of the following features:
it is configured, a target value, PMD_{track}, of a probability of path misdetection having been set, to determine the threshold value [symbol] for which the condition “p(d≤( [symbol] +εᵣ)sin(ε_{hdg}))≤PMD_{track}” is met, εᵣ being the error between the true and estimated distances between the satellite receiver and the beacon B1 and ε_{hdg} being the difference between said estimated heading value and the heading of the segment on which the beacon B1 is located as indicated in the database (13);
said electronic checking device being configured to assign the determined threshold value to a protection level PL and to determine that the estimated position is reliable or unreliable, respectively, depending on comparison of the protection level PL and of a predefined alert limit AL;
it is configured to compare the estimated value [symbol] with half the minimum distance between two adjacent segments of distinct paths, and, if said estimated value [symbol] is greater than said half the minimum distance, to identify as unreliable said estimated location at the time t.

### BRIEF DESCRIPTION OF THE DRAWINGS

The invention will be better understood and other features, details and advantages will become more clearly apparent on reading the non-limiting description that follows, and by virtue of the appended figures, which are given by way of example.

FIG. 1 is an illustration of the integrity or non-integrity of a location estimation;

FIG. 2 shows steps of a checking method 200 in one embodiment of the invention;

FIG. 3 schematically shows a railway system implementing one embodiment of the invention;

FIG. 4 illustrates the angles az′ₖ, azₖ and hdg considered in one embodiment of the invention;

FIG. 5 illustrates a case of error in estimation of track segment.

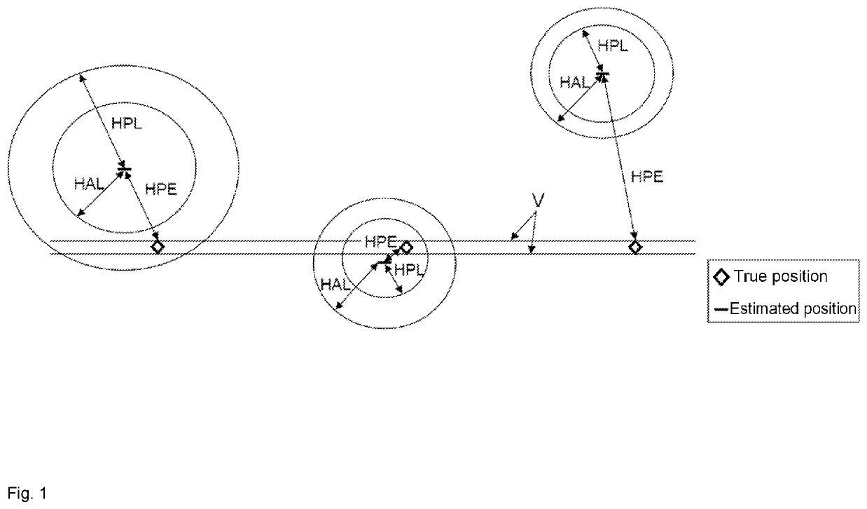

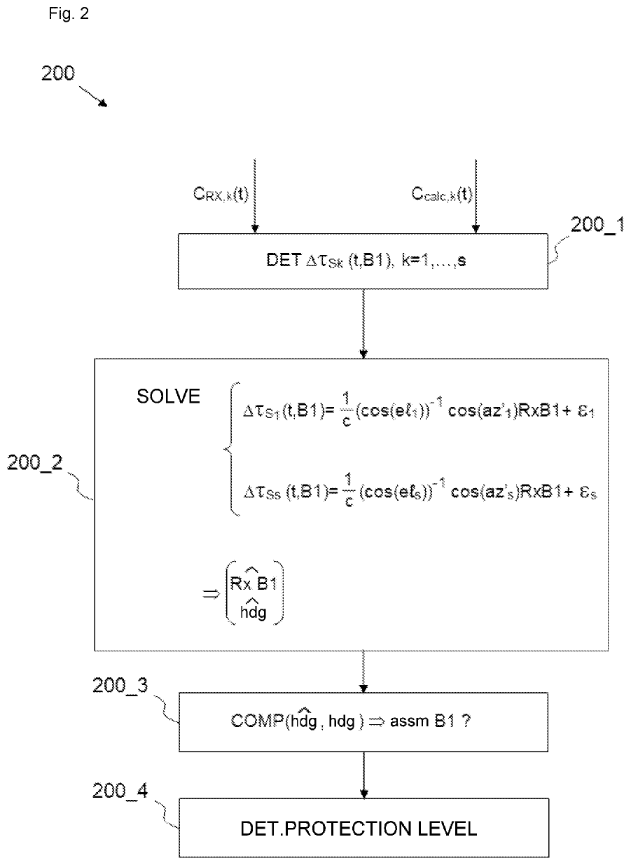

Identical references may be used in different figures to designate identical or comparable elements.

### DETAILED DESCRIPTION

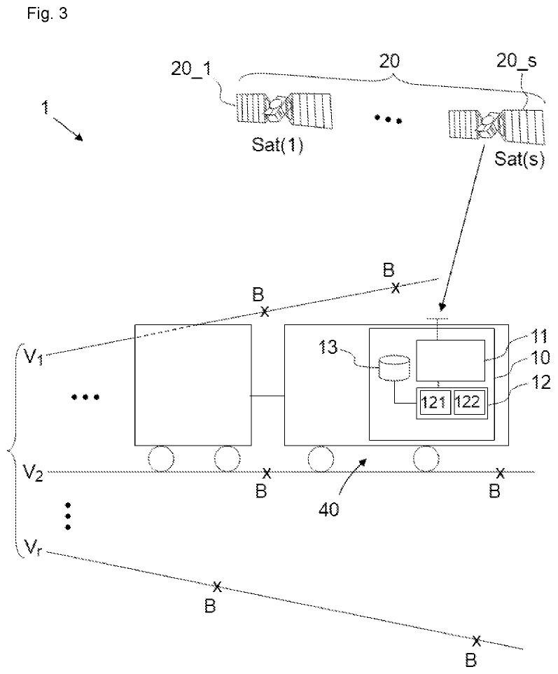

With reference to FIG. 3, a railway system 1 in one embodiment of the invention comprises one or more trains, including the train 40 shown in FIG. 3, that are configured to move over a predefined path or various predefined paths. Each of these paths is represented by a sequence of track segments (for example, left or right rail segments, or even—virtual—segments placed between the right and left rails, etc.).

The train 40 comprises an on-board electronic processing unit 10, which comprises: a unit Rx 11 comprising a standard GNSS satellite global positioning system;
an electronic locating unit 121;
an electronic checking unit 122; and
a topographic database 13.

In FIG. 3, track segments V1, V2, . . . , Vr have been shown.

Below, a predetermined position, or reference point, the spatial coordinates of which are known with precision will be called a “virtual beacon” or “beacon”, B. The beacons B are distributed over the track segments, for example on the line centered between the 2 track rails, or in proximity to the track, and for example at less than 50 cm from this line.

For example, the beacons are spaced apart from the beacons nearest thereto on the same track by a distance smaller than D, with D here equal to 4 m for example.

The track segments, and the beacons, are finite in number. Their 3D geographical position (with respect to a terrestrial reference frame) and their characteristics are referenced in the topographic database 13. Furthermore, said characteristics featuring in the database 13 are for example: segment identifier, beacon identifier, segment length, heading of the segment (also called route heading), association between segment identifier and identifier of the beacons located on the segment thus identified, value of geometrical parameters (for example Euler spiral or spline), characteristics of sequences in the railway network (for example: identifier of successor and predecessor segments).

The unit Rx 11, located on board the train 40, is configured to receive, in a synchronized local time base, geopositioning signals sent by a set 20 of GNSS geopositioning satellites 20_1, . . . , 20_s visible to the unit Rx 11, with s greater than or equal to 2.

The GNSS satellites for example comprise satellites of the US system GPS (GPS standing for Global Positioning System) and/or of the European system GALILEO and/or of the system Glonass or any other equivalent system. The positions, which may change over time, of the satellites are predetermined and known to the receiver Rx 11 (via ephemeris data).

In a known manner, the GNSS receiver in the unit Rx 11 is configured, given the received signals, to downshift frequency to baseband, to demodulate the signal and to extract therefrom a geopositioning signal comprising the repetition of a code at 1023 Hz. It is this signal in this form that will be denoted the “received signal” below, and that is used for the correlation computations.

Moreover, in a known manner, the GNSS receiver is further configured to extract time and carrier-phase information and to compute, for each satellite in sight, based on this received information, an estimate of the distance between the geolocation device itself and the satellite in sight, which estimate is also called pseudorange. The pseudorange is different from the actual distance between the satellite in question and the geolocation device because of errors in estimating propagation time, due for example to atmospheric conditions in the troposphere and in the ionosphere, and to the synchronization error of the internal clock of the geolocation receiver. However, it is possible using information transmitted by a plurality of separate satellites to eliminate common errors (including receiver time bias).

For example, the C/A code (C/A standing for Coarse Acquisition) in the GPS case is a digital signal composed of 1023 chips that repeats every millisecond. It will be noted that the term “chip” used in GNSS techniques is to be distinguished from the term “bit”, which is used to define a unit of information. The code used in the Galileo case is a PRN code.

The locating unit 121 is configured to estimate the position of the train 40 in question at the time t. The result of this location estimation comprises the position of the beacon that is for example estimated to be closest the train 40. It is in particular desired to validate that the obtained beacon is indeed located on the same track segment as the train. Specifically, being certain of the track of the train is a major safety element allowing accidents to be avoided.

In one embodiment, a plurality of hypotheses in respect of the estimated position of the train in question at the time t are provided.

In one embodiment, location is in particular estimated based on the satellite positioning signals received by the unit Rx 11 in its position to be estimated, and/or based for example on measurements from an on-board inertial measurement unit and/or based on measurements taken by an odometer. For example, the position of the train is estimated using a known technique called PVT (PVT standing for Position-Velocity-Time).

For example, exploiting the fact that the path of the train 10 necessarily follows the railway track segments, which are known and on which beacons are found, the locating unit 121 is able, in one embodiment, to search for the virtual beacon B (and therefore the associated track Vi) closest the location of the unit Rx 11 located on board the train 10 by exploiting the received GNSS signal and a priori knowledge of the fixed and predetermined positions of the virtual beacons B, which is imparted by the topographic database 13.

In such a case, the position of this virtual beacon is sought by correlating the GNSS signals received, at the local reference date t of the GNSS receiver, by the unit Rx 11, from each of the various visible satellites Sk, with expected code signals (replica code signals) of this satellite at the same local reference date t of the GNSS receiver, which expected code signals are computed for the positions Pi of virtual beacons Bi, for i varying from 1 to N (each of the positions Pi being one hypothesis in respect of the positioning of the train 40 at the time t): the likelihoods of the various hypotheses in respect of the position Pi of the train on the tracks are compared with one other, depending on the computed correlations, the hypothesis finally retained corresponding to a maximum of the likelihood function and therefore to a maximum correlation. Various methods applying these principles are for example described in FR 2 114 635, FR 1 601 449, FR 1 800 423, and EP 3 751 315.

### Integrity-Checking Method

The invention provides a method (one embodiment of which is described below) for checking the integrity of a position of the train 40 determined beforehand, by the locating unit 121, as corresponding to the position of one of the virtual beacons, denoted B1.

In the embodiment considered here, the checking unit 122 is configured to implement steps 200_1 to 200_6 of the integrity-checking method 200, considering at least two of the satellites (i.e. k is at least equal to two).

In one embodiment, the processing unit 10 comprises a processor, and a memory in which are stored software instructions that, when they are executed on the processor, implement the steps of the method 200.

The provided solution according to the invention uses the principle of correlation with virtual beacons and takes advantage of the fact that track-segment heading is known to verify the quality of the position estimations. Specifically, track-segment heading is known not only by virtue of the database 13, but is moreover a solution of geometric equations in the presence of at least 2 satellites.

Error detection according to the proposed integrity-checking solution is based on satellite code delays, which are for example obtained via correlation computations. The difference between the code delays measured at the receiver and the theoretical code delay computed for the beacon is used.

In a step 200_1, for each satellite Sk in question, the code delay between the positioning signal c_{RX,k}(t) delivered by satellite Sk, and received by the unit Rx 11 in its position, which it is desired to estimate, at the time t, and the replica code signal c_{calcB1,k}(t) of this satellite, at the same local reference date t of the GNSS receiver, that should, according to computations, have been received in the position P1 of the virtual beacon B1, is determined (for example, using correlation computations performed during the prior estimation of the position of train 40 by location unit 121).

Moreover, the theoretical code delay between the signal transmitted by satellite Sk and the signal reaching the beacon B1 may be modeled in the following way:

$${τ}_{{S}_{k}}^{th} ( t , B 1 ) = \frac{Sk ( t ) B 1}{c} + {ε}_{iono} ( Sk , B 1 , t ) + {ε}_{tropo} ( S k , B 1 , t ) + {ε}_{res} ( t )$$

where Sk(t)B1 is the distance between satellite Sk and the beacon B1 at the time t and c is the speed of light.

In this context, it is assumed that the ionospheric and tropospheric errors εᵢₒₙₒ and εₜᵣₒₚₒ are perfectly known, and that satellite orbit and clock errors are also included in these errors. εᵣₑₛ is the (unknown) residual error after correction for tropospheric, ionospheric and satellite clock and orbit errors. Receiver clock bias may be determined through computation of PVT.

The satellite clock and orbit errors are the same for the theoretical delay and measured delay.

The code delay between the signal transmitted by satellite Sk and the signal reaching the unit Rx 11 and measured by the unit Rx 11 may be expressed in the following form:

$${τ}_{{S}_{k}}^{meas} ( t , Rx ) = \frac{Sk ( t ) Rx}{c} + {ε}_{{Rx}_{clk}} ( t ) + {ε}_{iono} ( Sk , Rx , t ) + {ε}_{tropo} ( Sk , Rx , t ) + {ε}_{meas} ( t )$$

where Sk(t)Rx is the distance between satellite Sk and the receiver Rx 11 at the time t.

It is assumed that the integer ambiguity of the code delay is known.

Since the ionospheric and tropospheric delays are spatially correlated:

$${ε}_{iono} ( S 1 , B 1 , t ) \approx {ε}_{iono} ( S 1 , Rx , t ) ;$$

$${ε}_{tropo} ( S 1 , B 1 , t ) \approx {ε}_{tropo} ( S 1 , Rx , t ) ;$$

The computation of the difference is written:

$${Δτ}_{{S}_{k}} ( t , B 1 ) = {τ}_{{S}_{k}}^{meas} ( t , Rx ) - {τ}_{{S}_{k}}^{th} ( t , B 1 ) , i . e . :$$

by developing to the first order:

$$Δ {τ}_{{S}_{k}} ( t , B 1 ) = \frac{S 1 ( t ) Rx}{c} - \frac{S 1 ( t ) B 1}{c} + ε \approx \frac{1}{c} {( cos ( {el}_{k} ) )}^{- 1} cos ( {az}_{k}^{′} ) RxB 1 + ε .$$

This difference depends on the distance, denoted RxB1, between the beacon B1 and the receiver Rx 11, on the elevation elₖ of satellite Sk at the time t, and on a term describing relative azimuth az′ₖ that is also dependent on heading, which is denoted hdg, and which is measured between the line connecting the beacon B1 and receiver Rx 11 and North:

az′ₖ=hdg−azₖ modulo 2π where azₖ is the azimuth of satellite Sk at the time t, the value of which is known.

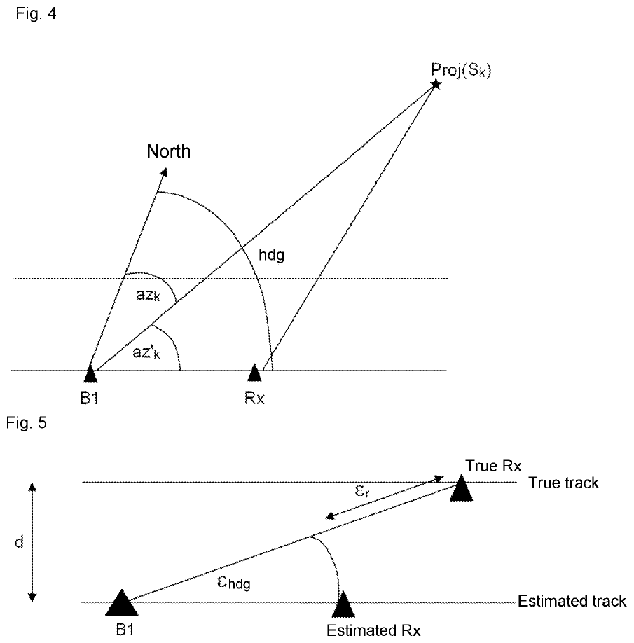

FIG. 4 shows the angles az′ₖ, azₖ and hdg relative to the path segment, to the virtual beacon B1, to the actual position of the unit Rx 11, to North and to the projection, Proj(Sk), of the position of the satellite onto the plane (local at the position of the train) of the Earth's surface.

Clock bias is removed after computation of PVT. The heading dependent term adds detection capabilities, as the track-segment headings are known, and track misdetection would be associated with use of an incorrect heading.

The integrity-checking method 200 consists in making it possible to defend against the case where a value of this metric Δτ_{S}_{ₖ}(t, B1) is low, but with a large beacon-receiver distance compensated by a large residual error. The heading information will in addition make it possible to guard against track misdetection.

It is assumed in the following step that the heading of the track segment on which the train is at the time t is unknown: the state vector the value of which is sought therefore has 2 dimensions, this state vector is

$$[ \begin{matrix} \\ hdg\end{matrix} ] .$$

Thus, in a step 200_2, a method for solving systems of non-linear equations is then implemented to estimate the vector

$$[ \begin{matrix} \\ hdg\end{matrix} ]$$

satisfying the following system of equations:

$$Δ {τ}_{{S}_{k}} ( t , B 1 ) = \frac{S 1 ( t ) Rx}{c} - \frac{S 1 ( t ) B 1}{c} + ε \approx \frac{1}{c} {( cos ( {el}_{k} ) )}^{- 1} cos ( {az}_{k}^{′} ) RxB 1 + ε ;$$

$$Δ {τ}_{{S}_{1}} ( t , B 1 ) = \frac{1}{c} {( cos ( {el}_{1} ) )}^{- 1} cos ( {az}_{1}^{′} ) RxB 1 + {ε}_{1}$$

$$Δ {τ}_{{S}_{s}} ( t , B 1 ) = \frac{1}{c} {( cos ( {el}_{s} ) )}^{- 1} cos ( {az}_{s}^{′} ) RxB 1 + {ε}_{s}$$

the values Δτ_{S}_{ₖ}(t,B1), k=1 to s, being those computed in step 200_1.

The variables ε₁ . . . , εₛ may be considered random system variables. Methods for solving the system are otherwise possible taking into account the statistical distribution of these random variables, method minimizing the estimation error taking into account these distributions (cf. least squares).

It is sought to limit the probability of not being on the correct track.

In a step 200_3, the heading estimated in step 200_2 is compared (if unit Rx 11 is supposed to be on the same track as the beacon B1) with the value of the heading of the track segment to which B1 belongs according to the database 13: if the difference (in absolute value) is greater than a predefined threshold, the estimated location of the machine at the time t is identified as an unreliable location and an action is triggered (alert etc.) to inform the processing unit and/or the user.

In one embodiment, this predefined tolerable heading-error threshold is set equal to 15°; the value is to be set depending on the desired performance and on the accuracy of detection of the beacon.

The heading and distance estimation errors are denoted as follows:

$$\{ \begin{matrix}{ε}_{r} = - \\ {ε}_{hdg} = hdg -\end{matrix}$$

FIG. 5 shows the case of a track estimation error, where “True Rx” is the actual position of the unit Rx 11 of the train 40 at the time t on a given track (called the true track), while the estimated position at the time t of the unit Rx 11 is located at the point “Estimated Rx”, the beacon B1 having been estimated, during estimation of the location of the train, to be the potential “virtual beacon closest the train and on the same track”.

There are an infinite number of pairs of distance error εᵣ and heading error ε_{hdg} allowing such a track error to be made.

These pairs are related by the following equation:

$$d = ( + {ε}_{r} ) sin ( {ε}_{hdg} )$$

where d is the distance between tracks.

For a limited heading error, i.e. one less than a predefined acceptable error threshold, a large distance error would be required to estimate a track incorrectly.

Theoretically therefore:

$$p ( incorrect ( adjacent ) track ) = p ( d = ( + {ε}_{r} ) sin ( {ε}_{hdg} ) )$$

To simplify the reasoning, the following inequality is considered:

$$p ( incorrect track ) = p ( d \leq ( + {ε}_{r} ) sin ( {ε}_{hdg} ) ) \leq p ( d \leq ( \frac{d}{2} + {ε}_{r} ) sin ( {ε}_{hdg} ) )$$

The right side of the equation is satisfied after a step of excluding (as unreliable) the beacon B1 for which [symbol] >d/2.

The errors must be bounded so that

$$p ( d \leq ( \frac{d}{2} + {ε}_{r} ) sin ( {ε}_{hdg} ) ) = {PND}_{track}$$

where PND_{track} is the probability of missed detection by the integrity check that an incorrect track has been estimated, which is a set value, for example in the example in question:

$$p ( d \leq ( \frac{d}{2} + {ε}_{r} ) sin ( {ε}_{hdg} ) ) = {PND}_{track} \leq {10}^{- 10}$$

It may be seen that in the case of detection of an incorrect track, the distance error is greater than d/2 whatever the heading error.

Since hypotheses in respect of the statistical distribution of the heading and distance errors are derivable from a satellite-signal error model, a zone of distancewise and headingwise protection such that PND_{track}=10⁻¹⁰, and in particular the aforementioned predefined tolerable heading error threshold, may be defined beforehand in this way.

In a step 2004, the reasoning may then be further simplified by making an allocation on the heading error (specifically, ε_{hdg} is known regarding the estimation of the position of the train at the time t), to deduce therefrom a distance error value for which the PMD_{track} of 10⁻¹⁰ is achieved. This distance error corresponds to a protection level for the track error event.

The problem may be widened by introducing an uncertainty into the knowledge of the map. Other error terms would in this context need to be introduced. Taking these uncertainties into account might allow the field of application to be opened up.

In one embodiment, the value of RxB1 estimated in step 200_2 is used to give a level of confidence in the beacon detection, after the track detection.

Computation of the protection level: the threshold value of [symbol] , denoted [symbol] , for which the condition “the probability of incorrect track detection, defined by p(d≤( [symbol] +εᵣ)sin(ε_{hdg})), is less than 10⁻¹⁰” is met is therefore determined; by assuming virtual-beacon continuity, the protection level PL is then determined: it is set equal to this estimated distance [symbol] for which “the probability of incorrect track detection is less than 10⁻¹⁰”.

The computed protection level PL is then compared with a predefined alert limit AL. If the protection level is greater than the alert limit AL, the position estimated at the time t is declared unreliable: an alert action is then triggered to warn of the unavailability of the position information. If the protection level is lower than the alert limit AL, the estimated position is declared reliable, and subsequent processing operations that depend on this estimated position are then carried out.

The invention is applicable not only in the case of a train that is stationary or being cold started, but also to a train in motion.

The invention, using heading, which quantity is known via the database, as variable, thus compensates for the uncertainty in the choice of a beacon. Error space is reduced by virtue of knowledge of the heading. This solution does not require sensors other than GNSS sensors, and does not require the form of the signal to be apprehended.

It will be noted that the invention may be exploited when carrying out processing with a view to checking the integrity of an estimated location of a mobile machine, but also when carrying out processing with a view to detecting, among a plurality of candidate virtual beacons corresponding to the location of a mobile machine, that or those that are valid and invalid.

The method 200, may be implemented by executing software instructions on a processor, as described above. Alternatively, either or both may be implemented by dedicated hardware, typically a digital integrated circuit, either an application-specific integrated circuit (ASIC) or a circuit based on programmable logic (for example an FPGA/Field-Programmable Gate Array).

The integrity-checking method according to the invention may of course be used, in sectors other than the railway sector, in any system in which it is necessary to estimate the position of a machine that is able to move only over a predetermined and finite set of paths, a database storing the geopositions of virtual beacons located on the paths. The value d is then the distance between the considered predefined path and the predefined path that is closest to the considered predefined path.

In one embodiment, the position-determining method and/or the method for checking the integrity of an estimated position may take into account multiconstellation aspects (idem. may take into account positioning signals on distinct frequencies): for example, the described integrity-checking method is carried out, delivering a heading and a protection level, using input from satellites of a constellation and using a first receiver, and is also carried out, in parallel, delivering another protection level, using a second on-board receiver and using input from satellites of another constellation. A final protection-level value is determined based on a combination or comparison of these protection levels. This allows detection capacity to be increased, and narrower protection levels to be obtained, as measurements at different frequencies/with different constellations are not affected by the same errors.

It will moreover be noted that measurement of codes in positioning signals was described above. The phases of the carriers of the positioning signals may also be considered instead of code measurements or in addition, both for position-estimating and for integrity-checking purposes.

1. A method for checking an estimated location of a machine configured to move over a set of one or more predefined paths (V1, V2) made up of path segments;
a satellite receiver located on board the machine being configured to receive, at a time t, geopositioning signals from a system of satellites comprising s satellites Sk, k=1 to s and s greater than or equal to 2;
a database storing the geographical coordinates of virtual beacons distributed over said set of one or more paths and further storing, for each virtual beacon, the heading of the path segment on which the virtual beacon is located;
a location at the time t of the machine as estimated indicating a virtual beacon B1 estimated as corresponding in principle to said location of the machine at the time t on the same path segment;
said method comprising the following steps, implemented by an electronic checking unit:
i/ for k=1 to s: computing the delay, Δτ_{S}_{ₖ}(t,B1), between the geopositioning signal received by the satellite receiver at the time t from satellite Sk and the theoretical geopositioning signal that should, according to computations, be received from satellite Sk at the time t at the position of the virtual beacon B1 such as defined by the geographical coordinates in the database;
ii/ estimating values [symbol] , [symbol] , of respective parameters hdg and RxB1, satisfying the system of equations:
$$Δ {τ}_{{S}_{1}} ( t , B 1 ) = \frac{1}{c} {( cos ( {el}_{1} ) )}^{- 1} cos ( {az}_{1}^{′} ) RxB 1 + {ε}_{1}$$
$$⋮$$
$$Δ {τ}_{{S}_{s}} ( t , B 1 ) = \frac{1}{c} {( cos ( {el}_{s} ) )}^{- 1} cos ( {az}_{s}^{′} ) RxB 1 + {ε}_{s}$$
where azₖ=hdg−azₖ modulo 2π and elₖ and azₖ are the, known, elevation and azimuth of satellite Sk at the time t, respectively;
iii/ comparing the estimated value [symbol] of the parameter hdg with the value, stored in the database, of the heading of the path segment on which the beacon B1 is located;
iv/ if the difference is greater than a first predefined threshold, said estimated location at the time t is identified as unreliable by said checking unit.

2. The checking method as claimed in claim 1, further comprising the following steps, a target value, PMD_{track}, of a path misdetection probability having been set: determining the threshold value [symbol] for which the condition “p(d≤( [symbol] +εᵣ)sin(ε_{hdg}))≤PMD_{track}” is met, d being the distance between the paths, εᵣ being the error between the true distance and the estimated distance, [symbol] , between the satellite receiver and the beacon B1 and ε_{hdg} being the difference between the heading estimated in step ii and the heading of the segment on which the beacon B1 is located as indicated in the database;
assigning the determined threshold value to a protection level PL;
determining that the estimated position is reliable or unreliable, respectively, depending on comparison of the protection level PL and a predefined alert limit AL.

3. The checking method as claimed in claim 1, wherein the value [symbol] , estimated in step ii/ is compared with half the minimum distance between two adjacent segments of distinct paths, and if said estimated value RxB1 is greater than said half the minimum distance, said estimated location at the time t is identified as unreliable by said checking unit.

4. A computer program, intended to be stored in the memory of an electronic checking device and further comprising a microcomputer, said computer program comprising instructions that, when they are executed on the microcomputer, implement the steps of a method according to claim 1.

5. An electronic device for checking an estimated location of a machine configured to move over a set of one or more predefined paths (V1, V2) made up of path segments; a satellite receiver located on board the machine being configured to receive, at a time t, geopositioning signals from a system of satellites comprising s satellites Sk, k=1 to s and s greater than or equal to 2; a database storing the geographical coordinates of virtual beacons (B) distributed over said set of one or more paths and further storing, for each virtual beacon, the heading of the path segment on which the virtual beacon is located;
a location at the time t of the machine as estimated indicating a virtual beacon B1 estimated as corresponding in principle to said location of the machine at the time t on the same path segment;
said electronic checking device being configured to compute, for k=1 to s, a delay, Δτ_{S}_{ₖ}(t,B1), between the geopositioning signal received by the satellite receiver at the time t from satellite Sk and the theoretical geopositioning signal that should, according to computations, be received from satellite Sk at the time t at the position of the virtual beacon B1 such as defined by the geographical coordinates in the database;
said electronic checking device being configured to estimate values, [symbol] , [symbol] , of respective parameters hdg and RxB1, satisfying the system of equations:
$$Δ {τ}_{{S}_{1}} ( t , B 1 ) = \frac{1}{c} {( cos ( {el}_{1} ) )}^{- 1} cos ( {az}_{1}^{′} ) RxB 1 + {ε}_{1}$$
$$⋮$$
$$Δ {τ}_{{S}_{s}} ( t , B 1 ) = \frac{1}{c} {( cos ( {el}_{s} ) )}^{- 1} cos ( {az}_{s}^{′} ) RxB 1 + {ε}_{s}$$
where az′ₖ=hdg−azₖ modulo 2π and elₖ and azₖ are the, known, elevation and azimuth of satellite Sk at the time t, respectively;
said electronic checking device being configured to compare the estimated value [symbol] of the parameter hdg with the value, stored in the database, of the heading of the path segment on which the beacon B1 is located, and, if the difference is greater than a first predefined threshold, to identify said estimated location at the time t as unreliable.

6. The electronic device for checking an estimated location as claimed in claim 5, configured, a target value, PMD_{track}, of a probability of path misdetection having been set, to determine the threshold value [symbol] for which the condition “p(d≤( [symbol] +εᵣ)sin(ε_{hdg}))≤PMD_{track}” is met, d being the distance between the paths, Eᵣ being the error between the true distance and the estimated distance, [symbol] , between the satellite receiver and the beacon B1 and ε_{hdg} being the difference between said estimated heading value and the heading of the segment on which the beacon B1 is located as indicated in the database;
said electronic checking device being configured to assign the determined threshold value to a protection level PL and to determine that the estimated position is reliable or unreliable, respectively, depending on comparison of the protection level PL and of a predefined alert limit AL.

7. The electronic device for checking an estimated location as claimed in claim 5, configured to compare the estimated value [symbol] with half the minimum distance between two adjacent segments of distinct paths, and, if said estimated value [symbol] is greater than said half the minimum distance, to identify as unreliable said estimated location at the time t.
